(19) United States
(12) Patent Application Publication
(10) Pub. No.: US 2024/0011790 A1
(43) Pub. Date: Jan. 11, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Yukio NUMAKAMI, Tokyo (JP); Masakazu FUJIKI, Kanagawa (JP)

(21) Appl. No.: 18/338,645

(22) Filed: Jun. 21, 2023

(30) Foreign Application Priority Data
Jul. 7, 2022 (JP) 2022-109743

(51) Int. Cl. G01C 21/00; G06T 7/73; G01S 17/89

(52) U.S. Cl. CPC G01C 21/383; G06T 7/74; G01S 17/89

(57) ABSTRACT

An information processing apparatus that is able to reduce the workload for the creation of maps in a plurality of regions acquires region information including at least one of a shape feature or a pattern feature relating to a predetermined region; calculates a degree of similarity between a first region and a second region based on first region information relating to the first region and second region information relating to the second region that have been acquired; and in a case in which the degree of similarity that has been calculated is at or above a predetermined threshold, acquires second map information relating to the second region based on first map information relating to the first region.

### BACKGROUND OF THE INVENTION

### Field of the Invention

The present invention relates to an information processing apparatus, an information processing method, a storage medium, and the like, relating to map creation.

### Description of Related Art

Technologies have been proposed in which moving bodies such as unmanned carriers (AGVs (Automatic Guided Vehicles), and the like are moved automatically within an environment such as a factory or a physical distribution warehouse. In a case in which the movable apparatus is moved automatically, there are cases in which the creation of maps of the actual space, and self-position-posture-measurements within the actual space are performed. As a method for doing so, for example, the SLAM (Simultaneous Localization And Mapping) method is known.

Image data captured using a camera, laser image data measured using LiDAR (Light Detection And Ranging), or inertia data (acceleration, angular velocity, or the like) measured using an IMU (Inertial Measurement Unit) are used as the sensor data for the position and orientation measurements.

In Japanese Unexamined Patent Application, First Publication No. 2017-107456, a method is provided for easily creating a map when a movable apparatus that is travelling automatically in a pre-determined region creates a map relating to the predetermined region for use in the position and orientation measurements by reading a plurality of information storage mediums that have been placed in the predetermined region.

However, in the method of Japanese Unexamined Patent Application, First Publication No. 2017-107456, in a case in which the movable apparatus automatically travels in a plurality of regions, it is necessary to create a map for each region, which therefore presents the problem that the operation of creating maps becomes complex.

### SUMMARY OF THE INVENTION

An information processing apparatus according to one aspect of the present invention comprises: at least one processor or circuit configured to function as:
a region information acquisition unit configured to acquire region information including at least one of a shape feature or a pattern feature relating to a predetermined region;
a degree of region similarity calculating unit configured to calculate a degree of similarity between a first region and a second region based on first region information relating to the first region and second region information relating to the second region that have been acquired by the region information acquisition unit; and a map information determining unit configured to acquire second map information relating to the second region based on first map information relating to the first region in a case in which the degree of similarity that has been calculated by the degree of region similarity calculation unit is at or above a predetermined threshold.

Further features of the present invention will become apparent from the following description of embodiments with reference to the attached drawings.

### BRIEF DESCRIPTION OF THE DRAWINGS

FIG. 1 is a functional block diagram showing an overall configurational example of a movable apparatus system provided with an information processing apparatus according to the First Embodiment.

FIG. 2 is a diagram showing an example of a hardware configuration of the information processing apparatus according to the First Embodiment.

FIG. 3 is a functional block diagram showing a configurational example of the primary units of a movable apparatus system that is provided with the information processing apparatus according to the First Embodiment.

FIG. 4 is a flowchart showing processing steps for an information processing apparatus 120 according to the First Embodiment.

FIG. 5 is a functional block diagram showing a configurational example of a movable apparatus system provided with an information processing apparatus according to the Fifth Embodiment.

FIG. 6 is a flowchart showing the processing procedures for the information processing apparatus 120 according to the Fifth Embodiment.

FIG. 7 is a flowchart showing the processing procedures for a movable apparatus system according to the Fifth Embodiment.

FIG. 8 is a flowchart showing the processing procedures for a movable apparatus system according to the Sixth Embodiment.

FIG. 9 is a flowchart showing the processing procedures for a movable apparatus system according to the Seventh Embodiment.

FIG. 10A is a diagram showing one example of a display screen according to the First Embodiment, and B to D are diagrams showing examples of display screens according to the Fifth Embodiment.

FIG. 11 is a diagram showing a screen that is displayed on a display apparatus by a display unit 132 in the Fifth Embodiment when a second SLAM map is automatically created while movement controlling the movable apparatus system 100.

FIG. 12 is a diagram showing an example of a case in which, in the Fifth Embodiment, a user is using the movable apparatus system 100.

### DETAILED DESCRIPTION OF THE INVENTION

Hereinafter, with reference to the accompanying drawings, favorable modes of the present invention will be described using Embodiments. In each diagram, the same reference signs are applied to the same members or elements, and duplicate descriptions will be omitted or simplified.

### First Embodiment

In the present embodiment, an example will be explained in which a movable apparatus system is used that automatically travels by SLAM using LiDAR (abbreviated below as LiDAR SLAM). In addition, in the present embodiment, a map that is created in order to perform position and orientation measurements with SLAM using LiDAR is referred to as a SLAM map.

In addition, in the present embodiment, the movable apparatus automatically travels in a plurality of regions for which the shapes of the layouts are the same. For example, this is a case in which in a building such as a hotel, an apartment building, or the like, the movable apparatus automatically travels on a plurality of floors in which the layout of each floor is the same.

In a case in which the SLAM map is created in LiDAR SLAM, it is necessary that the user makes the movable apparatus travel by pushing it by hand, or through the operation of a remote control or the like, on the routes inside of the predetermined region in which the movable apparatus will travel automatically. In a case in which SLAM maps are created in a plurality of regions it is necessary for the user to make the movable apparatus travel in all of the regions by manual operation, and this creates a larger workload for the creation of the maps.

However, if the shapes of the layouts in the plurality of regions is similar, there is a high possibility that a SLAM map that has been created for a specific region can be reused as is for another region.

In this context, in the present embodiment, a degree of region similarity is calculated that shows to what extent the shapes of the layouts for a first region and a second region are similar in a first region for which a SLAM map has previously been created, and a second region for which a SLAM map will now be created. In the calculation of the degree of region similarity, for example, CAD (Computer Aided Design) data, which is one type of design data for a structure, is compared to serve as the data including the shapes of the layouts.

In addition, the creation method for the second SLAM map in the second region is determined according to the calculated degree of region similarity. In the present embodiment, in a case in which the acquired degree of region similarity is high in relation to the shapes of the layouts, it is judged that it is possible for the first SLAM map to be reused, and it is determined that the first SLAM map that was created in the first region will be duplicated and created to serve as the second SLAM map for the second region.

Note that in the present embodiment, the degree of region similarity is a value that indicates to what extent the first region and the second region are similar in relation to the shapes of the layouts within the regions. The degree of similarity relating to the shapes of the layouts is made the degree of shape similarity, and the degree of region similarity standardizes the degree of shape similarity and indicates this as one parameter. Specifically, the value for the lowest degree of similarity is made 0.0, and the value for the highest degree of similarity is made 1.0.

In addition, in the present embodiment, CAD data is blueprint data including the structure and layout of a building in a predetermined region in which the movable apparatus is made to travel automatically. As the CAD data, there is 2D CAD, which is represented using two-dimensional data, and 3D CAD, which is represented using three-dimensional data. However, the present embodiment uses 3D CAD.

### <Explanation of the System Configuration Drawings>

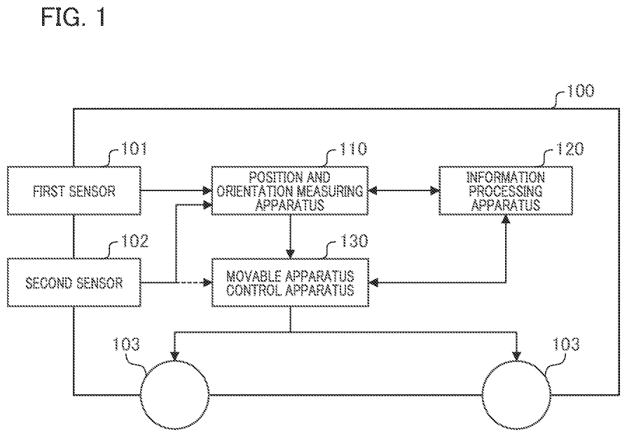

FIG. 1 is a functional block diagram showing an example of the entire configuration of a movable apparatus system provided with the information processing apparatus according to the First Embodiment.

Note that a portion of the functional blocks that are shown in FIG. 1 are realized by a CPU 21 that serves as a computer included in an information processing apparatus 120 executing a computer program that has been stored on an external memory 24 that serves as a storage medium. However, a portion or the entirety of these functional blocks may also be realized by hardware. An Application Specific Integrated Circuit (ASIC), a processor (reconfigurable processor, DSP), or the like can be used as the hardware.

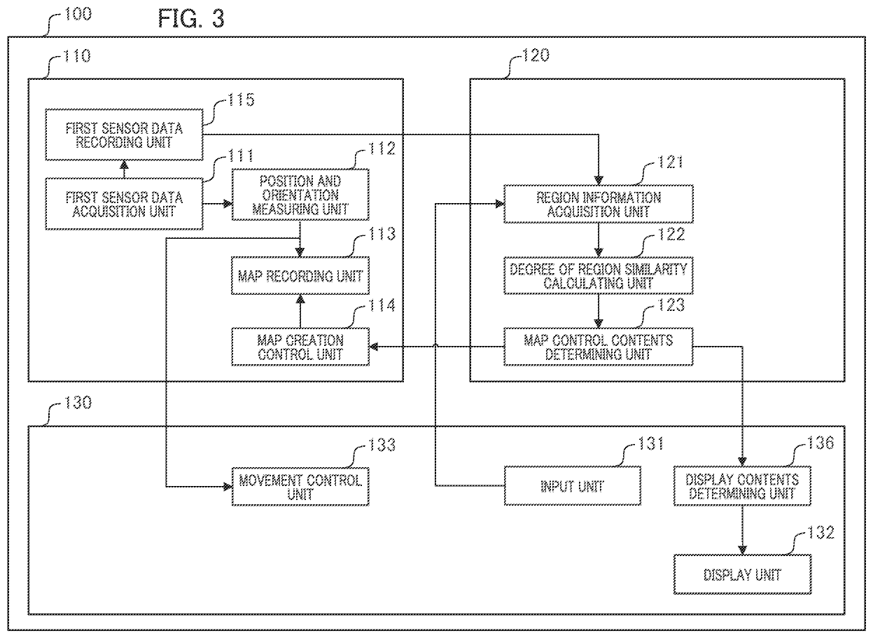

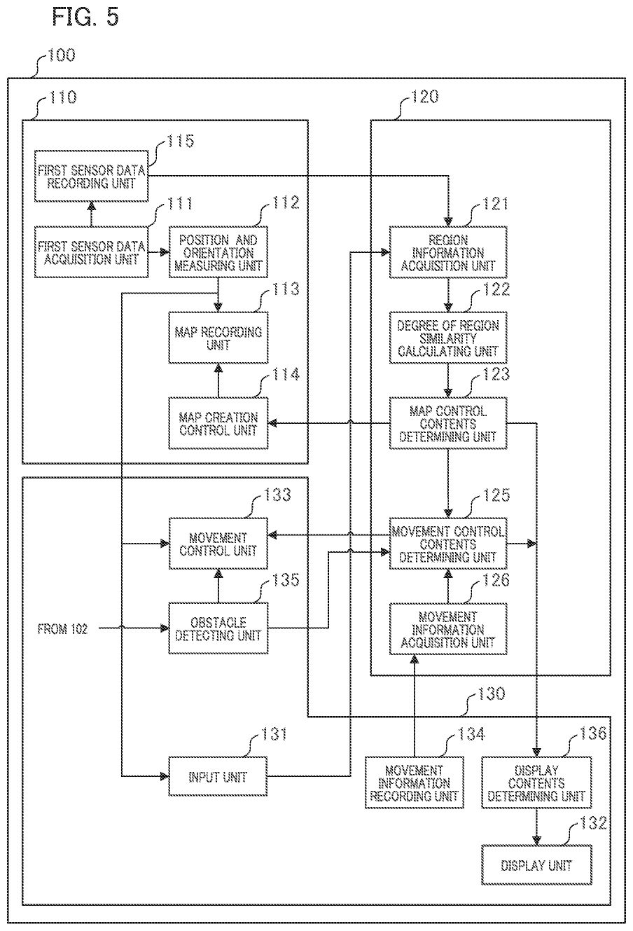

In addition, each of the functional blocks that are shown in FIG. 1 do not need to be encased in the same body, and may also be configured by separate apparatuses that are connected to each other via a signal path. Note that the explanation given above in relation to FIG. 1 also applies in the same manner to the functional block diagrams that are shown in FIG. 3, and FIG. 5.

A movable apparatus system 100 includes a first sensor 101, a second sensor 102, a drive unit 103, a position and orientation measuring apparatus 110, the information processing apparatus 120, a movable apparatus control apparatus 130, and the like.

The first sensor 101 generates first sensor data by measuring a predetermined region in which the movable apparatus system 100 travels. The first sensor 101 in the present embodiment is LiDAR, and generates point group data relating to the position and orientation of an object that were measured to serve as the first sensor data.

The second sensor 102 generates sensor data by measuring the forward direction in which the movable apparatus system 100 travels. The second sensor 102 in the present embodiment is a distance sensor, and generates distance data until an object that exists in the forward direction of the movable apparatus system 100 to serve as second sensor data. The drive unit 103 is a drive apparatus that includes a motor or the like for moving the movable apparatus system 100.

The position and orientation measuring apparatus 110 acquires the first sensor data that was generated by the first sensor 101, and performs position and orientation measurements and SLAM map creation at the same time in a predetermined region based on the first sensor data. The information processing apparatus 120 determines the creation method for the second SLAM map in the second region based on the degree of region similarity between the first region for which a SLAM map has already been created, and the second region for which a SLAM map will now be created.

The movable apparatus control apparatus 130 controls the drive unit 103 based on the position and orientation information that has been acquired from the position and orientation measuring apparatus 110, and controls the automatic travel (autonomous travel) of the movable apparatus system 100. In addition, the movable apparatus control apparatus 130 acquires the second sensor data from the second sensor 102, and detects obstacles that exist in the forward direction of the movable apparatus system 100.

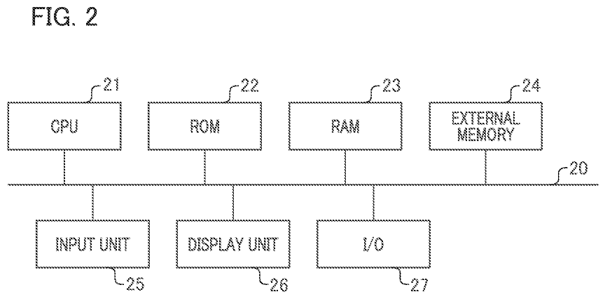

FIG. 2 is a diagram showing an example of a hardware configuration of the information processing apparatus 120 according to the First Embodiment. 21 denotes a CPU that serves as a computer, which executes respective processing in the present embodiment, and performs the control of each device that has been connected to a system bus 20. 22 denotes ROM, and stores a program for a BIOS and a boot program. 23 denotes RAM, and is used as the primary storage apparatus for the CPU 21. 24 denotes an external memory, and stores the computer program that is executed by the CPU 21 of the information processing apparatus 120, and the like.

An input unit 25 is a keyboard and mouse, and a robot controller, and performs processing relating to the input of information and the like, as well as user operations. A display unit 26 outputs the calculation results of the information processing apparatus 120 to a display apparatus according to commands from 21. Note that the display apparatus is a liquid crystal display apparatus, a projector, an LED indicator, or the like, and the type of display apparatus does not matter. 27 is an I/O.

FIG. 3 is a functional block diagram showing a configurational example of the primary units of a movable apparatus system that is provided with the information processing apparatus according to the First Embodiment. The position and orientation measurement apparatus 110 includes a first sensor data acquisition unit 111, a position and orientation measuring unit 112, a map recording unit 113, a map creation control unit 114, and a first sensor data recording unit 115.

In addition, the information processing apparatus 120 includes a region information acquisition unit 121, a degree of region similarity calculating unit 122, and a map control contents determining unit 123. In addition, the movable apparatus control apparatus 130 includes an input unit 131, a display unit 132, a movement control unit 133, and a display contents determining unit 136.

The first sensor data acquisition unit 111 acquires the first sensor data from the first sensor 101. The position and orientation measuring unit 112 measures the position and orientation of the movable apparatus system 100 based on the first sensor data that has been acquired by the first sensor data acquisition unit 111, and creates a SLAM map. The details of the position and orientation measurements will be explained below.

The map recording unit 113 records the SLAM map that was created by the position and orientation measuring unit 112. The map creation control unit 114 controls the creation of the SLAM map according to map control contents that have been determined by the map control contents determining unit 123. In the present embodiment, the map creation control unit 114 duplicates the first SLAM map that was created in the first region and recorded on the map recording unit 113, and creates this to serve as the second SLAM map in the second region.

The first sensor data recording unit 115 records the first sensor data that has been acquired by the first sensor data acquisition unit 111. In the present embodiment, the first sensor data recording unit 115 records the first sensor data that was measured inside of the first region, and the second sensor data that was measured inside of the second region.

The region information acquisition unit 121 is a functional block for acquiring region information that includes at least one of a shape feature or pattern feature relating to a predetermined region, and the region information acquisition unit 121 acquires first region information and second region information. In the First Embodiment, the region information acquisition unit 121 acquires CAD data to serve as region information including the shapes of the layouts relating to a region from the input unit 131.

The degree of region similarity calculating unit 122 calculates the degree of region similarity between the first region and the second region based on the first region information and the second region information that have been acquired by the region information acquisition unit 121. Note that for example, the first region information and the second region information may each be region information corresponding to an entire floor, or they may also each be region information corresponding to predetermined limited small regions (for example, a predetermined room, or a predetermined section) within a floor.

The map control contents determining unit 123 (a map information determining unit) determines the creation method for the second SLAM map in the second region based on the degree of region similarity that has been calculated by the degree of region similarity calculating unit 122.

The user inputs the first region information and the second region information using the input unit 131. Conversely, the first region information and the second region information may also be stored in a database in advance. In the present embodiment, the first and second region information that are input by the input unit 131 are CAD data.

The display unit 132 displays the display contents that were determined by the display contents determining unit 136 on a screen of the display apparatus that is provided to an apparatus in the vicinity of the movable apparatus system 100 or to the movable apparatus system 100. The movement control unit 133 makes the movable apparatus system 100 automatically travel (autonomously travel) by controlling the drive unit 103 based on the position and orientation measurement results from the position and orientation measuring unit 112.

The display contents determining unit 136 determines the contents to be displayed by the display unit 132 on the display apparatus based on the control contents for the second SLAM map that have been determined by the map control contents determining unit 123.

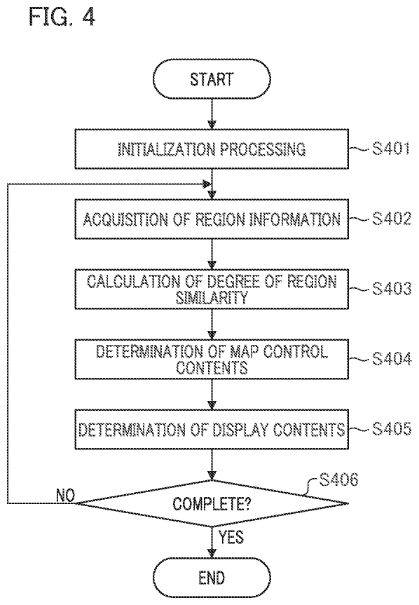

FIG. 4 is a flowchart showing the processing procedures for the information processing apparatus 120 according to the First Embodiment. Note that the operations for each step of the flowchart in FIG. 4 are performed by the CPU 21 that serves as a computer inside of the information processing apparatus 120 executing the computer program that has been stored on the memory.

In step S401, the initialization processing for the information processing apparatus 120 is performed. Specifically, the map control contents determining unit 123 reads a list in which a plurality of combinations of degrees of region similarity and control contents for use in determining the control contents have been listed (a control contents table).

In step S402 (a region information acquisition step), the region information acquisition unit 121 acquires first CAD data to serve as the first region information, and second CAD data to serve as the second region information from the input unit 131. For example, this data is acquired by downloading the first CAD data and the second CAD data from a database. That is, step S402 acquires region information including at least one of a shape feature or a pattern feature relating to a predetermined region.

In step S403 (a degree of region similarity calculation step), the degree of region similarity calculating unit 122 calculates the degree of region similarity between the first region and the second region based on the first region information and the second region information. In the present embodiment, the degree of region similarity calculation unit 122 calculates the sum of the distance between corresponding points on model surfaces of a 3D model of the first CAD data and a 3D model of the second CAD data.

In addition, calculation is performed such that the smaller the sum of the distance is, the higher the degree of shape similarity is, and the larger the sum of the distance, the lower the degree of shape similarity is. That is, step S403 calculates the degree of similarity between the first region and the second region based on the first region information relating to the first region and the second region information relating to the second information.

In step S404, the map control contents determining unit 123 references the table configured by the combination of the above-described degrees of region similarity and control contents based on the degree of region similarity calculated in step S403, and determines the creation method for the second SLAM map in the second region.

That is, step S404 (a map information determining step) acquires second map information relating to the second region based on first map information relating to the first region in a case in which the degree of similarity is at or above a predetermined threshold.

In addition, in a case in which the degree of shape similarity in the degree of region similarity that has been calculated is at or above a predetermined threshold, it is judged that it is possible to reuse the first SLAM map, and it is determined that it is possible to duplicate the first SLAM map that was created in the first region and to create this to serve as the second SLAM map for the second region. That is, in a case in which the degree of similarity is at or above the predetermined threshold, the first map information is used to serve as the second map information.

In contrast, in a case in which the degree of shape similarity is less than the first threshold, it is judged that the first SLAM map cannot be reused, and it is determined that the second SLAM map will be newly created. In addition, the map control contents determining unit 123 sends the creation method for the second SLAM map that has been determined to the map creation control unit 114.

In step S405, the display contents determining unit 136 determines the contents to be displayed on the screen based on the control contents for the second SLAM map that were determined in step S404. In addition, the display contents determining unit 136 sends the display contents that have been determined to the display unit 132.

In step S406, whether or not to complete the entirety of the processing for the processing apparatus 120 is judged. Specifically, in a case in which the movable apparatus system 100 has arrived at its destination and automatic travelling is completed, the processing is ended. If this is not the case, the processing returns to step S402, and the processing continues with the next region as its subject.

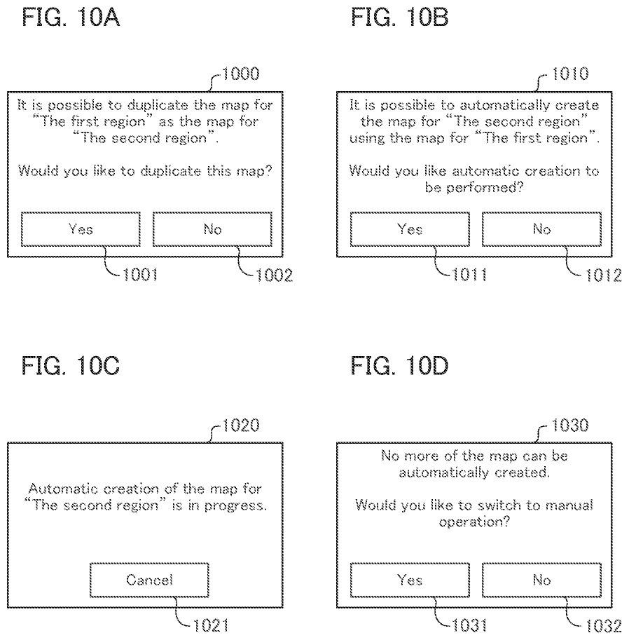

FIGS. 10A to D are diagrams showing examples of display screens according to the First Embodiment and the Fifth Embodiment. FIG. 10A is one example of a screen that is displayed on a display apparatus by the display unit 132 according to the display contents that have been determined by the display contents determining unit 136 in the First Embodiment.

In FIG. 10A, 1000 is an example of a screen for when confirming with a user whether or not to duplicate the first SLAM map that was created in a first region and to create this to serve as the second SLAM map for the second region. Upon 1001 being pressed, the first SLAM map is duplicated, and created to serve as the second SLAM map for the second region. Upon 1002 being pressed, the second SLAM map is not created by duplicating the first SLAM map.

In this manner, in the example in 10A, in the movable apparatus system 100, the user is notified that it is possible to create the second SLAM map in the second region by duplicating the first SLAM map for the first region. Therefore, it is possible to reduce the workload for creating the second SLAM map.

Note that in the example in FIG. 10A, the display contents determining unit 136 confirms with the user whether or not to duplicate the first SLAM map that was created in the first region and to create this to serve as the second SLAM map for the second region. However, the present invention is not limited thereto. For example, this may be automatically created without performing user confirmation.

That is, in a case in which the calculated degree of shape similarity and degree of pattern similarity are sufficiently high, even if the second SLAM map is automatically created by duplicating the first SLAM map, the risk that the precision of the position and orientation measurements in the second region will be lowered is small. Therefore, it becomes possible to eliminate the procedure for the user confirmation by automatically creating the map without user confirmation.

Note that in the First Embodiment, although 3D CAD data was used to serve as the region information, the present invention is not limited thereto, and 2D CAD information may also be used. In this case, the degree of region similarity calculating unit 122 calculates the degree of shape similarity by comparing the shape of 2D models of the first CAD data and the second CAD data.

In addition, the region information is not limited to CAD data, and it is sufficient if this information is information that includes the shapes of the layouts of a region and for which the differences in the shapes of the layouts between regions can be compared. For example, this may also be a blueprint that shows the shapes of the layouts that have been recorded using an electronic data format other than the CAD data format, such as three-dimensional model data for a building such as BIM (Building Information Modeling) or the like.

In addition, in the present embodiment, the region information acquisition unit 121 acquired one of each of first region information corresponding to the entirety of a predetermined floor, and second region information for a separate floor from the input unit 131. However, the present invention is not limited thereto. For example, a plurality of CAD data including the shapes of layouts from more narrow small ranges that are relatively the same may also be acquired.

In this case, the degree of region similarity detecting unit 122 calculates the degree of shape similarity by comparing the region information for each of the ranges that are relatively the same, and calculates the sum-total thereof to serve as the final degree of shape similarity. It is thereby also possible to calculate the degree of shape similarity for regions from a large range that has been separated into a plurality of region information, thereby increasing the convenience for the user.

In addition, in the examples that have been explained above, the degree of region similarity calculating unit 122 calculated the degree of shape similarity based on the sum of the distance between corresponding points on model surfaces of 3D models of the first CAD data and the second CAD data. However, the present invention is not limited thereto, and each of the first CAD data and the second CAD data may be converted to a two-dimensional image format, and the degree of shape similarity may also be calculated from the ratio of the matching image features.

In addition, in the present embodiment, the degree of region similarity calculating unit 122 calculated the degree of shape similarity based on the shapes of the layouts of the entire range of the first region information and the second region information that were acquired. However, the present invention is not limited thereto, and for example, the degree of similarity may also be calculated for only a comparatively narrow designated range that has been designated from among the first region information by a user.

In this case, the region information acquisition unit 121 further acquires the designated region information that is made the subject of the degree of region similarity calculation in addition to the first region information and the second region information, and the degree of region similarity calculating unit 122 calculates the degree of region similarity based on the designated region information.

By configuring the invention in this manner, it is possible to eliminate regions that had no direct relation to the creation of the first SLAM map, such as regions that are not included in the first SLAM map or the like, from among the acquired region information from the start, and it is possible to increase the calculation accuracy for the degree of region similarity.

In the present embodiment, the map control contents determining unit 123 determined that the first SLAM map that was created in the first region would be duplicated and created to serve as the second SLAM map for the second region. However, the present invention is not limited thereto. For example, if the degree of shape similarity and the degree of pattern similarity are incredibly high, it may also be determined that the first SLAM map will not be duplicated, and the first SLAM map will also be used in the second region.

In this manner, according to the First Embodiment, in the movable apparatus system 100, the second SLAM map in the second region is created by duplicating the first SLAM map for the first region, and therefore, it is possible to reduce the workload for the creation of the second SLAM map.

### Second Embodiment

In the First Embodiment, an example was shown in which, in a case in which the shapes of the layouts in a first region and a second region are similar, it is determined that the first SLAM map will be duplicated and created to serve as the second SLAM map.

In the Second Embodiment, in a case in which a portion of the shapes of the layouts in the first region and the second region are different, and the first SLAM map cannot be created to serve as the second SLAM map as it is, it is determined that only the maps for the portions for which the shapes of the layouts are similar will be reused. The operations in the Second Embodiment are approximately the same as those in FIG. 4, and the points of difference will be explained.

In step S403, the degree of region similarity calculating unit 122 separates the first region information and the second region information into subareas (small regions), and calculates the degree of region similarity between the first region and the second region for each subarea.

In step S404, the map control contents determining unit 123 refers to the control contents table, and determines a subarea for which the degree of region similarity is, for example, at or above the first threshold, and judges that it is possible to re-use the portion of the first SLAM map corresponding to this subarea. In addition, it is determined that only the corresponding portion from this first SLAM map will be extracted and duplicated and created to serve as the second SLAM map for the second region.

In step S405, the display contents determining unit 136 displays the second SLAM map on the screen so that it is possible to identify the portion that has been reused from the first SLAM map. The other steps of FIG. 4 are the same as those in the First Embodiment, and explanations thereof will be omitted.

According to the Second Embodiment, it is possible to re-use the first SLAM map for the portions of the first and second regions that are similar, and to create the second SLAM map even in a case in which a portion of the first region information and the second region information are different. Therefore, it is possible to reduce the workload for the creation of the second SLAM map.

### Third Embodiment

In the First Embodiment and the Second Embodiment, CAD data, which is one kind of design data for a structure, was used as the region information that includes the shapes of the layouts, and the degree of shape similarity was calculated by comparing the shapes from the design data for both regions.

In the Third Embodiment, an example is explained for a case in which CAD data, which is design data, cannot be used as the region information, because there have been changes to a predetermined region after construction to the building, In this case, in the Third Embodiment, measurement data that has been measured by the first sensor 101 is used as the region information, and the degree of shape similarity is calculated by comparing the shapes of the measurement data and the design data.

Specifically, in the Third Embodiment, first point group data from the surface of an object that exists in the first region that has been measured by the first sensor 101, which is LiDAR, is acquired.

The degree of shape similarity is calculated by comparing the shapes for this first point group data and the second CAD data, which is design data for the second region. Note that in the Third Embodiment, the first sensor 101 is 3D LiDAR, and the first point group is 3D data.

In the Third Embodiment, a configuration is used that is approximately the same as the configurational example in FIG. 3. However, in FIG. 3, the region information acquisition unit 121 acquires the first region information and the second region information. In the present example, the region information acquisition unit 121 acquires the first point group data in the first region from the first sensor data recording unit 115 to serve as the first region information, and acquires the second CAD data in the second region from the input unit 131 to serve as the second region information.

In the Third Embodiment, the processing is performed using approximately the same flow as that in FIG. 4. However, in the Third Embodiment, in step S402 in FIG. 4, the region information acquisition unit 121 acquires the first point group data from the first sensor data recording unit 115 to serve as the first region information, and the second CAD data from the input unit 131 to serve as the second region information.

In step S403, the degree of region similarity calculating unit 122 calculates the degree of similarity between the first region and the second region based on the first region information and the second region information.

In the Third Embodiment, the degree of region similarity calculating unit 122 calculates the sum of the distance between corresponding points on model surfaces of 3D models of 3D data for an object of the first point group and the second CAD data. In addition, the calculation is performed such that the smaller the sum of the distance is, the higher the degree of shape similarity becomes, and the larger the sum of the distance is, the lower the degree of shape similarity becomes.

According to the Third Embodiment, even in a case in which the first CAD data that includes the shape of the layout of the first region cannot be used, or a case in which this data does not exist, it is possible to reuse the first SLAM map corresponding to the similar second region, and therefore, the convenience for the user is increased.

### Fourth Embodiment

In the Third Embodiment, the region information acquisition unit 121 acquired the first point group data to serve as the first region information, and the second CAD data to serve as the second region information. However, in the Fourth Embodiment, second point group data is acquired to serve as the second region information in the same manner as the first region information.

In this case, the degree of region similarity calculating unit 122 calculates the degree of shape similarity by comparing the shapes of the 3D data for objects from the first point group data and the second point group data. It is thereby possible to re-use the first SLAM map that has been associated with the first region, and which is saved in advance, even in a case in which the second CAD data in the second region cannot be used, or in a case in which this data does not exist, and the convenience for the user is thereby increased.

### Fifth Embodiment

In the First Embodiment, an example was explained of a method in which in a case in which the shapes of the layouts of the first region and the second region are similar, the pre-existing first SLAM map that was made in the first region is duplicated, and created to serve as a the second SLAM map in the second region.

In the Fifth Embodiment, an example will be explained in which even in a case in which a portion of the shapes of the layouts differs in the first region and the second region, the second SLAM map is created by reusing the first SLAM map. Note that in the Fifth Embodiment as well, an example is explained in which the present invention has been applied to a movable apparatus system that automatically travels (autonomously travels) using LiDAR SLAM in the same manner as in the First Embodiment to the Fourth Embodiment.

In a case in which the shapes of the layouts of the first region and the second region are different, if the second SLAM map that was created by duplicating the first SLAM map using the methods that were explained in the First Embodiment to the Fourth Embodiment was used, there would be cases in which it would not be possible to make the movable apparatus travel automatically.

That is, the accuracy of the position and orientation measurements by LiDAR SLAM would be lowered in the portions for which the shapes of the layouts differ, and the movable apparatus system could not be made to safely travel automatically. Therefore, it is necessary to newly create a second SLAM map for the second region.

In a case in which the portions for which the shapes of the layouts of the first region and the second region differ does not directly affect the automatic travelling of the movable apparatus system, there is a high possibility that the movable apparatus system will also be able to move along travel paths in the second region having the same form as travelling paths that it moved on in the first region. Note that a case in which portions that do not directly affect the automatic travelling of the movable apparatus system differ is for example, a case in which there is a shelf on the upper direction of a wall that does not exist in the other region, a case in which the shape of a column at the edge of an aisle is different, or the like.

In such a case, in the Fifth Embodiment, along with determining the control contents of the second SLAM map based on the degree of region similarity for the first region and the second region, first movement information for the movable apparatus system from when the first SLAM map was created in the first region is also acquired. In addition, movement control contents are determined for the movable apparatus system in the second region based on the degree of region similarity for the first region and the second region and the acquired first movement information.

Specifically, in the Fifth Embodiment, the movement of the movable apparatus system is controlled so as to move on travel paths in the second region having the same shape as travel paths that the movable apparatus system moved on when the first SLAM map was created in the first region.

In addition, it is determined that the second SLAM map will be created by reusing the first SLAM map while performing movement control. It is thereby possible to automatically create the second SLAM map while performing movement control on the movable apparatus system in the second region based on the first movement information without any manual operations by the user.

In addition, in a case in which the portions for which the shapes of the layouts in the first region and the second region differ have a direct effect on the automatic travel (autonomous travel) of the movable apparatus system, in the Fifth Embodiment, the automatic movement control of the movable apparatus is stopped in the second region.

In addition, the control is switched to manual operations by the user, and the creation of the second SLAM map continues. It is thereby possible to decrease the risk of the movable apparatus system colliding with a structure due to differences in the shapes of the layouts, and to increase the safety.

FIG. 5 is a functional block diagram showing a configurational example of a movable apparatus system provided with an information processing apparatus according to the Fifth Embodiment. An explanation of the functional blocks that are the same as those in FIG. 3, which showed a functional configurational example of a movable apparatus system provided with the information processing apparatus that was explained in the First Embodiment, will be omitted, and only the functional blocks that differ from those in the First Embodiment will be explained.

The information processing apparatus 120 is configured by the region information acquisition unit 121, the degree of region similarity calculating unit 122, the map control contents determining unit 123, the movement control contents determining unit 125, the movement information acquisition unit 126, and the like. In addition, the movable apparatus control apparatus 130 is configured by the input unit 131, the display unit 132, the movement control unit 133, the movement information recording unit 134, the obstacle detection unit 135, and the display contents determining unit 136.

The movement control contents determining unit 125 acquires the degree of region similarity that was calculated by the degree of region similarity calculating unit 122, and the first movement information (movement history information) relating to the movement of the movable apparatus system 100 in the first region that was acquired by the movement information acquisition unit 126. In addition, the movement control contents for the movable apparatus system 100 in the second region are determined based on the degree of region similarity and the movement history information.

The movement information acquisition unit 126 acquires the movement information for the movable apparatus system 100 from the movement information recording unit 134. In the present embodiment, the movement information is information including the movement history of the movable apparatus system 100 in a predetermined region. The movement information recording unit 134 records the movement information (movement history information), which is information relating to the movement of the movable apparatus system 100.

Note that the movement history information is information relating to the movement history of a movable apparatus from when the first map information was created in the first region. However, the movable apparatus from when the above-described first map information was created may also be a movable apparatus that is different from the movable apparatus system 100 in the present embodiment.

The obstacle detection unit 135 acquires second sensor data from the second sensor 102, and detects obstacles that exist in front of the movable apparatus system 100. In the present embodiment, the obstacle detection unit 135 is primarily used to detect whether or not a structure that would become an obstacle to the movement in the travelling direction of the movable apparatus system 100 is present due to differences in the shapes of the layouts.

The display contents determining unit 136 determines the contents that will be displayed on the display apparatus based on the control contents for the second SLAM map that were determined by the map control contents determining unit 123 and the movement control contents for the movable apparatus system 100 in the second region that were determined by the movement control contents determining unit 125.

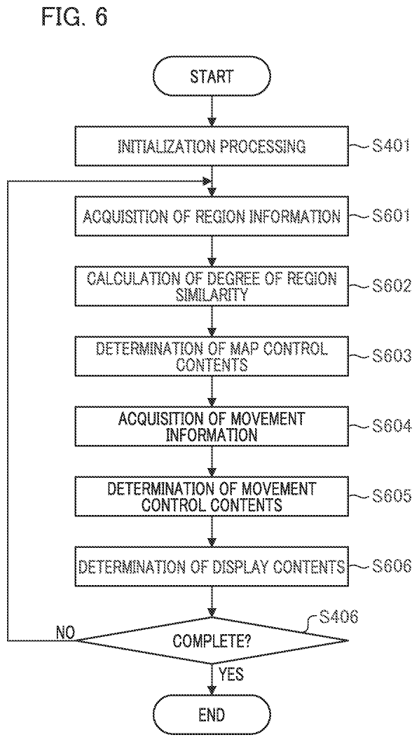

FIG. 6 is a flowchart showing the processing procedures for the information processing apparatus 120 according to the Fifth Embodiment. An explanation of the steps that are the same as those in FIG. 4 will be omitted, and only the steps that are different from the steps in the First Embodiment to the Fourth Embodiment will be explained.

Note that in FIG. 6, processing is continuously executed in the same manner as in FIG. 4. Also note that the operations for each step of the flowchart in FIG. 6 are performed by the CPU 21 that serves as the computer inside of the information processing apparatus 120 executing the computer program that has been stored on the memory.

Step S601 to step S603 are the same as step S402 to step S404. In step S604, the movement information acquisition unit 126 acquires the first movement information (movement history information) for the movable apparatus system 100 in the first region from the movement information recording unit 134. That is, the region information acquisition unit acquires the movement history information for the movable apparatus in the first region.

In step S605, the movement control contents determining unit 125 determines the movement control contents for the movable apparatus system 100 in the second region based on the degree of region similarity that was calculated in step S602, and the first movement information in the first region that was acquired in step S604. The determination method for the movement control contents will be described below.

In step S606, the display contents determining unit 136 determines the contents to be displayed on the screen based on the control contents for the second SLAM map that were determined in step S603, and the movement control contents for the movable apparatus system 100 in the second region that were determined in step S605.

In the Fifth Embodiment, the movement information acquisition unit 126 acquires the movement history information for the movable apparatus system 100 from when the first SLAM map was created in the first region to serve as the first movement information. The movement history information in the Fifth Embodiment is an information group in which the information relating to the movement direction, the movement distance, and movement velocity of the movable apparatus system on a two-dimensional plane at a specific point in time are grouped together, and these become a chronologically continuous list.

In the Fifth Embodiment, the movement control contents determining unit 125 references the previously described control contents table, and determines the movement control contents for the movable apparatus system in the second region based on the degree of shape similarity and the first movement information.

In addition, in step S603 of the present embodiment, in a case in which the degree of shape similarity is at or above the first threshold, the map control contents determining unit 123 judges that it is possible to reuse the first SLAM map. Then, it is determined that the first SLAM map that was created in the first region will be duplicated and created to serve as the second SLAM map for the second region.

If, in a case in which the degree of shape similarity is at or above the first threshold, and the shapes of the layouts for the first region and the second region are very similar, there will be no problem with a second SLAM map that has been created by duplicating the first SLAM map. Therefore, the movement control contents determining unit 125 determines that movement control will not be performed in the second region.

If there is a case in which the degree of shape similarity is less than the first threshold but is at or above the second threshold (provided that the first threshold>the second threshold), then a portion of the shapes of the layouts for the first region and the second region will be different. At this time, the movement control contents determining unit 125 determines that the movable apparatus system 100 will be movement controlled such that it will automatically move along the paths that are the same as the paths on which the movable apparatus system 100 moved when the first SLAM map was created in the first region, based on the first movement information.

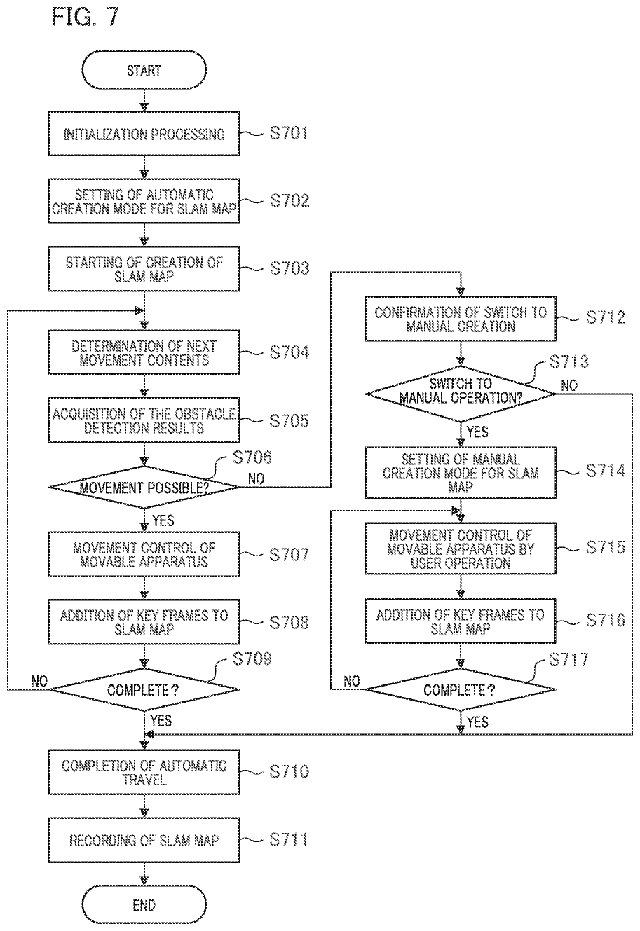

That is, the movement control contents determining unit 125 controls the movement of the movable apparatus in the second region based on the degree of similarity and the movement history information. In this manner, in a case in which the degree of similarity is lower than the predetermined threshold (the first threshold), along with the movements of the movable apparatus being controlled, the second map information is created based on an output from a sensor that has been provided on the movable apparatus, as will be described below. The control for this case is a flow such as that which is shown in FIG. 7.

If there is a case in which the degree of shape similarity is less than the second threshold, the shapes of the layouts for the first region and the second region are greatly different, and therefore, it is assumed that movement control cannot be performed, and the movement control contents determining unit 125 determines that movement control will not be performed in the second region.

FIG. 7 is a flowchart showing the processing procedures for the movable apparatus system according to the Fifth Embodiment. Note that the operations for each step in the flowchart in FIG. 7 are performed by the CPU 21 that serves as the computer inside of the information processing apparatus 120 executing a computer program that has been stored on a memory.

In FIG. 7, the movable apparatus system 100 is movement controlled according to the control contents for the second SLAM map that were determined by the map control contents determining unit 123 and the movement control contents for the movable apparatus system 100 in the second region that were determined by the movement control contents determining unit 125. In addition, the second SLAM map is automatically created while the movement control is performed.

In step S701, initialization processing for the movable apparatus system 100 is performed for the automatic creation of the second SLAM map. Specifically, the movement control unit 133 movement controls the movable apparatus system 100 until the point on the map where the creation of the second SLAM map in the second region will begin. The point on the map where the creation of the second SLAM map will begin corresponds to the point on the map where the creation of the first SLAM map began in the first region, and not only the positions, but also the postures, are aligned.

In step S702, the display unit 132 displays a screen on the display screen that confirms with the user whether or not to create the second SLAM map by automatically performing movement control on the movable apparatus system 100 according to the determination of the display contents determining unit 136.

1010 in FIG. 10B is an example of the screen for when confirming with the user whether or not to create the second SLAM map by automatically performing movement control on the movable apparatus system 100 in step S702. Upon 1011 being pressed down, the processing transfers to automatic creation mode for the SLAM map. Upon 1012 being pressed down, the flow in FIG. 7 is completed. After confirming with the user, the map control contents determining unit 123 sets the automatic creation mode for the second SLAM map.

Note that in the Fifth Embodiment, when in automatic creation mode for the SLAM map, the input unit 131 is made to not receive movement control for the movable apparatus system 100 by manual operations. 1020 in FIG. 10C is an example of a screen displaying a message that automatic creation of the second SLAM map in the second region is in progress in step S702. 1021 is a button for stopping automatic creation.

In step S703, the position and orientation measuring unit 112 starts the creation of the second SLAM map and starts the position and orientation measurements. In addition, in step S704, the movement control contents determining unit 125 retrieves one of a plurality of groups of the movement history information included in the first movement information in order, and determines the movement control contents (movement direction, movement distance, and movement velocity) for when the movable apparatus system 100 will be moved.

In step S705, the movement control contents determining unit 125 acquires the obstacle detection results for in front of the movable apparatus system 100 from the obstacle detection unit 135.

In step S706, the movement control contents determining unit 125 judges whether or not it is possible to perform movement control on the movable apparatus system 100 in accordance with the movement control contents that were determined in step S704, based on the obstacle detection results that were acquired in step S705.

This means that whether or not it is possible to continue the movement control of the movable apparatus system 100 is determined according to the difference in the shapes of the layouts. If there is a case in which there is a high possibility that the movable apparatus system 100 will collide with an obstacle if it is movement controlled in accordance with the movement control contents that have been determined, it is judged that movement is not possible, and the processing proceeds to step S712. If this is not the case, the processing proceeds to step S707.

In step S707, the movement control unit 133 controls the movement of the movable apparatus system 100 based on the movement control contents that were determined by the movement control contents determining unit 125. In addition, in step S708, the position and orientation measuring unit 112 adds key frames to the second SLAM map and updates the second SLAM map based on the first sensor data that was acquired from the first sensor data acquisition unit 111 according to the movements of the movable apparatus system 100.

In this manner, in a case in which the degree of similarity is lower than the first threshold but at or above the second threshold, along with controlling the movement of the movable apparatus, the second map information is created based on an output from a sensor that has been provided on the movable apparatus. In this context, the key frame is an image of a building, a sign, a marker, or the like that becomes a landmark for specifying that location, and is an image that has been acquired by the first sensor 101 of the movable apparatus system 100 or a camera that has been separately provided. In step 707, articles that could become landmarks are automatically added to serve as the key frames.

In step S709, the movement control contents determining unit 125 determines whether or not to complete the movement control based on the first movement information. Specifically, in a case in which all of the movement history information that is included in the first movement information has been read out, the processing proceeds to step S710. In addition, in a case in which the stop button that has been displayed on the screen has been pressed down by the user, the processing proceeds to step S710. In the case of No in step S709, the processing returns to step S704, and the processing continues with the next movement history information as its subject.

In step S710, the position and orientation measuring unit 112 stops the position and orientation measurement together with completing the automatic travelling, and the creation of the second SLAM map is completed. In addition, in step S711, the map recording unit 113 records the second SLAM map that was created, and the processing is ended.

In contrast, in a case of No in step S706, the processing proceeds to step S712. In step S712, the display unit 132 displays a screen on the display apparatus that confirms with the user if it is alright to switch over to movement control by manual operations by the user according to the determination of the display contents determining unit 136.

1030 in FIG. 10D is an example of a screen for when it is being confirmed with the user if it is alright to switch over to movement control by manual operations by the user in step S712. Upon 1031 being pressed down, the processing transitions to a manual creation mode for the SLAM map. Upon 1032 being pressed down, the flow in FIG. 7 is completed.

In step S713, the map control contents determining unit 123 receives the results for confirming the switch over to manual operations from the user, and in a case in which this will be switched over to manual operations, the processing proceeds to step S714. In contrast, in a case in which this will not switch over to manual operations, the display unit 132 displays a message on the screen of the display unit that the creation of the second SLAM map will be completed according to the determination of the display contents determining unit 136, and the processing proceeds to step S710.

In step S714, the map control contents determining unit 123 determines to switch over the settings to the manual creation mode for the SLAM maps and to continue the creation of the second SLAM map. Furthermore, the display unit 132 displays a message on the screen of the display apparatus that the creation of the second SLAM map in the second region will be switched over to manual operations.

In this manner, the present embodiment has a manual mode for the movement control of the movable apparatus in the second region that is based on instructions from the user. Note that in the present embodiment, it is assumed that during the manual creation mode for the SLAM maps, the input unit 131 receives the movement control for the movable apparatus system 100 by manual operations.

In step S715, the movement control unit 133 acquires the movement operation contents that were manually operated by the user from the input unit 131, and performs movement control on the movable apparatus system 100. In addition, in step S716, the position and orientation measuring unit 112 automatically adds key frames to the SLAM map in the same manner as in step S708. Conversely, the key frames may also be added manually.

In step S717, the map control contents determining unit 123 decides whether or not to complete the creation of the SLAM map by manual operation. Specifically in a case in which the user has instructed the completion of the map creation, the processing proceeds to step S710. In the case of No in step S717, the processing returns to step S715, and the processing continues.

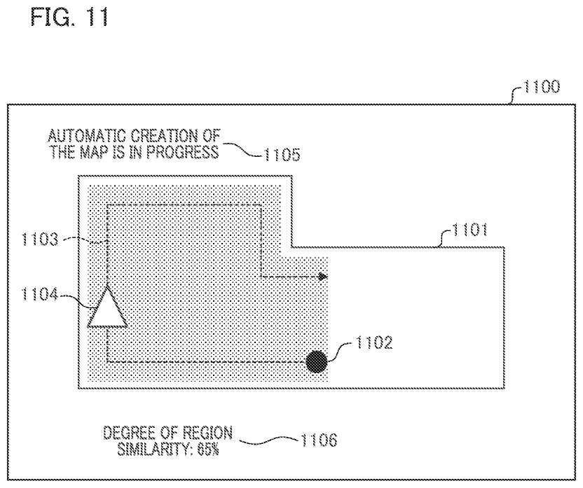

FIG. 11 is a diagram showing an example of a screen that is displayed on the display apparatus by the display unit 132 when the second SLAM map is being automatically created while movement controlling the movable apparatus system 100 in the Fifth Embodiment.

1100 is the entirety of the screen. 1101 is the shapes of the layouts of the second region. In the Fifth Embodiment, determinations are performed based on the second CAD data. 1102 is the point on the map where the creation of the second SLAM map in the second region begins.

1103 is the travel route on which the movable apparatus system 100 is movement controlled in the second region. 1104 is the current point on the map for the movable apparatus system 100. 1105 is the current status. 1106 is the calculation result for the degree of region similarity.

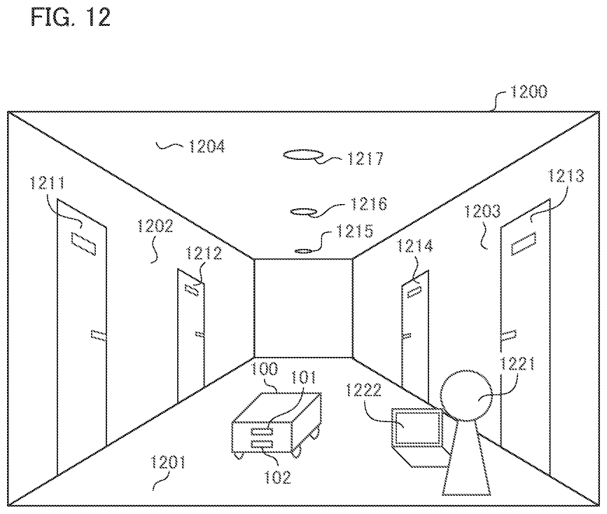

FIG. 12 is a diagram showing an example of a case in which, in the Fifth Embodiment, a user is using the movable apparatus system 100, and shows an example of a usage screen in which the second SLAM map is being automatically created by movement controlling the movable apparatus system 100 in the second region.

1200 is a screen of the entirety of the second region, and for example, is a specific floor in a building such as a hotel, an apartment building, or the like. 1201 is a path in the second region, 1202, and 1203 are walls in the second region, 1204 is the ceiling in the second region, and 1211 to 1214 are doors in the second region.

1215 to 1217 are lights in the second region, 1221 is the user who is using the movable apparatus system 100, and 1222 is a note PC that displays the state of the movable apparatus system 100. The display apparatus of the note PC 1222 displays a screen according to the display contents that were determined by the display contents determining unit 136 in the Fifth Embodiment.

For example, in the case of the screen 1010 that is shown in FIG. 10B, the user 1221 judges whether or not to automatically create the second SLAM map in the second region 1200 by looking at the written explanation that has been displayed on the screen. If the user decides to perform automatic creation and presses down the button 1011, the second SLAM map is automatically created by performing movement control in the second region 1200 based on the first movement information for the movable apparatus system 100.

According to the Fifth Embodiment, even in a case in which a portion of the shapes of the layouts for the first region and the second region are different, the movable apparatus system 100 is moved on travel paths of the same shape as those from when the first SLAM map was created in the first region based on the first movement information.

In addition, it becomes possible to automatically generate the second SLAM map in the second region without manual operations from the user while performing movement control. The workload for the creation of the second SLAM map can thereby be reduced.

Furthermore, even in a case in which the portions for which the shapes of the layouts for the first region and the second region differ directly affect the automatic travel of the movable apparatus system 100, the creation of the second SLAM map is continued by switching over to manual operations by the user. It is thereby possible to decrease the risk of the movable apparatus system 100 colliding with a structure due to differences in the shapes of the layouts, and to increase the safety.

Note that in the Fifth Embodiment, the degree of region similarity calculating unit 122 may also calculate the degree of region similarity by adding weight according to the degree to which the layout that is included in the region information will affect the movement control of the movable apparatus system 100 when comparing the shapes of the layouts of the first region and the second region.

For example, in a case in which the shapes of the layouts are similar with respect to structures that are directly related to the movement of the movable apparatus system 100, such as paths and walls, doors, elevators, or the like, the degree of shape similarity will be calculated as being higher than normal.

In contrast, in a case in which the shapes of the layouts are similar with respect to the structures that are not directly related to the movement of the movable apparatus system 100, such as the windows, the ceilings, or the like, the degree of shape similarity is calculated as lower than usual. It thereby becomes possible to increase the probability of success for the movement control of the movable apparatus system 100 in the second region.

In addition, in the Fifth Embodiment, the movement information acquisition unit 126 acquired the movement history information for the movable apparatus system 100 to serve as the first movement information. However, the present invention is not limited thereto. That is, the first movement information may be any kind of information as far as it is possible for the movable apparatus system 100 to also be able to move in the second region on travel paths for which the shapes are the same as those from when the first SLAM map was created in the first region.

For example, if it is possible to perform movement control on the movable apparatus system 100 by remote control operations by a user, the operation history information relating to the remote-control operations from when the first SLAM map was created in the first region may also be used.

In this case, it is sufficient if an information group in which operation commands for the movement direction (forward 45°, or the like), operation commands for the movement velocity, and information relating to the operation command times, all on a two-dimensional plain, are grouped together and a chronologically continuous list of these groups is used to serve as the operation history information.

In addition, in the Fifth Embodiment, the movement control contents determining unit 125 determined to perform control such that the movable apparatus system 100 would automatically move on paths that were the same as paths on which it moved when the first SLAM map was created in the first region. However, the present invention is not limited thereto.

For example, the movement control contents determining unit 125 may also change the movement velocity of the movable apparatus system 100 in the second region according to the degree of region similarity. Specifically, in a case in which the degree of region similarity is high, the chances of the movable apparatus system 100 colliding with a structure due to a difference in the shapes of the layouts are low, and therefore, it is possible to shorten the time relating to the automatic creation of the second SLAM map by increasing the movement velocity.

In contrast, in a case in which the degree of region similarity is low, the chances of the movable apparatus system 100 colliding with a structure due to differences in the shapes of the layouts are high, and therefore it is possible to reduce the risk of a collision by decreasing the movement velocity.

In addition, the movement control contents determining unit 125 may also change the movement range of the movable apparatus system 100 in the second region according to the degree of region similarity. Specifically, the movement control contents determining unit 125 may split the first region and the second region into subareas, and calculate the degree of region similarity for each subarea.

In addition, in the second region, movement control is performed based on the first movement information for the movable apparatus system 100 in subareas for which the degree of region similarity is high, and movement control is performed by switching over to manual operations by the user in the subareas in which the degree of region similarity is low. It is thereby possible to increase the portions for which the movable apparatus system 100 can be automatically movement controlled in the second region, and is possible to decrease the user workload for creating the map.

In addition, the movement control contents determining unit 125 may also change the posture (orientation) of the second sensor 102 more frequently when moving the movable apparatus system 100 in the second region more frequently according to the degree of region similarity. Specifically, in a case in which the degree of region similarity is low, there is a high chance that the movable apparatus system 100 will collide with a structure due to differences in the shapes of the layouts, and therefore, the posture (orientation) of the second sensor 102 may also by moved at a greater frequency than in a case in which the degree of region similarity is high.

It is thereby made easier to detect obstacles that exist in the surroundings of the movable apparatus system 100, and it is possible to decrease the risk of collisions.

In addition, in the Fifth Embodiment, the display contents determining unit 136 displayed a screen such as FIG. 10 B in step S702 of FIG. 7. That is, a screen was displayed that confirms with the user whether or not to create the second SLAM map by automatically movement controlling the movable apparatus system 100. However, the present invention is not limited thereto.

For example, the planned travel route on which the movable apparatus system 100 will be movement controlled in the second region may also be displayed. It is thereby possible for the user to confirm in advance whether or not the movable apparatus system 100 can travel in the second region without colliding with a structure, and it is possible to increase the safety.

In addition, in the Fifth Embodiment, the display contents determining unit 136 displayed a screen such as that in FIG. 10D in step S712 of FIG. 7. That is, automatic creation of the second SLAM map could not be continued due to the differences in the shapes of the layouts of the first region and the second region, and therefore, a screen was displayed to confirm with the user if it is alright to switch over to movement control by manual operations by the user. However, the present invention is not limited thereto.

For example, a second SLAM map that has been created by automatic creation may also be displayed. In addition, the portions that were not created by automatic creation in the second region may also be displayed. It is thereby possible to know which portions should be movement controlled by manual operations by the user, and the usefulness is increased.

In addition, in the Fifth Embodiment, the display contents determining unit 136 may also display a second SLAM map that was created by automatic creation when the creation of the second SLAM map is completed in step S710 in FIG. 7.

It is thereby possible for the user to confirm the quality of the second SLAM map that was created by automatic creation. If there is a case in which the second SLAM map has not been made according to the user's expectations, the SLAM map for a different region is reused, or it is made such that it can be judged that the second SLAM map will be created by manual operation or the like, and the usefulness is increased.

In addition, in the Fifth Embodiment, the display contents determining unit 136 determined the contents to be displayed on the display unit 132 based on the control contents for the second SLAM map that were determined by the map control contents determining unit 123. However, the present invention is not limited thereto. For example, a warning or the like may also be further displayed in the display contents according to the degree of region similarity that has been calculated by the degree of region similarity calculating unit 122.

That is, in a case in which the degree of region similarity is low, there is a high probability that the movable apparatus system 100 will collide with a structure due to the differences in the shapes of the layouts, and therefore, the degree of the warning to the user may be displayed as being enlarged. Specifically, for example, display may be performed such that the warning display is emphasized on the screen the lower that the degree of similarity is according to the degree of region similarity.

In this manner, according to the Fifth Embodiment, even in a case in which a portion of the shapes of the layouts for the first region and the second region are different, the movable apparatus system 100 is moved on the travel paths for which the shape is the same as those from when the first SLAM map was created in the first region based on the first movement information.

In addition, it becomes possible to automatically generate the second SLAM map in the second region without manual operation by the user while movement control is performed. It is thereby possible to decrease the workload for the creation of the second SLAM map.

Furthermore, even in a case in which the portions for which the shapes of the layouts of the first region and the second region are different directly affect the automatic travel of the movable apparatus system 100, the creation of the second SLAM map continues by switching over to manual operations by the user. It is thereby possible to reduce the risk of the movable apparatus system 100 colliding with a structure due to differences in the shapes of the layouts, and to increase the safety.

### Sixth Embodiment

Next, the Sixth Embodiment will be explained, in which the second SLAM map is updated while the movable apparatus system automatically travels in the second region, after the second SLAM map has been created by duplicating the first SLAM map.

Note that in the Sixth Embodiment, the second SLAM map is updated while making the movable apparatus system move based on path information that has been set in the movable apparatus system in the first region. In the Sixth Embodiment, processing is performed with the same flow as that in the flowchart in FIG. 6. Only the points of difference with FIG. 6 will be explained.

In step S604, the movement information acquisition unit 126 acquires the first movement information for the movement system 100 in the first region from the movement information recording unit 134. In the Sixth Embodiment, the movement information acquisition unit 126 further acquires information that includes the travel path from when the movable apparatus system automatically travels based on the first SLAM map in the first region to serve as the first movement information.

That is, information relating to a travel path for making the movable apparatus system 100 automatically travel via a plurality of waypoints that have been set in the first SLAM map is acquired.

In step S605, the movement control contents determining unit 125 determines the movement control contents of the movable apparatus system 100 in the second region based on the degree of region similarity and the first movement information. That is, in a case in which the degree of shape similarity is at or above the first threshold (or the second threshold), it is determined that control will be performed such that the movable apparatus 100 also moves in the second region on travel paths that are the same as the travel paths on which it automatically travelled based on the first SLAM map in the first region.

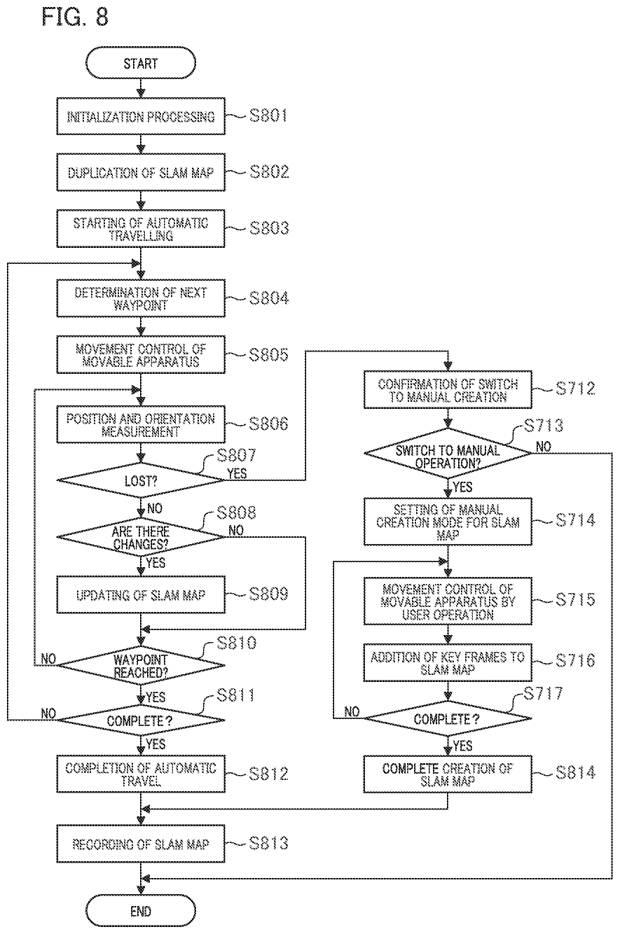

FIG. 8 is a flowchart showing the procedures of the processing for the movable apparatus system according to the Sixth Embodiment. In FIG. 8, the movable apparatus system 100 is made to automatically travel according to the control contents for the second SLAM map that have been determined by the map control contents determining unit 123, and the movement control contents for the movable apparatus system 100 in the second region that have been determined by the movement control contents determining unit 125. In addition, the second SLAM map is updated while the movable apparatus system 100 is travelling.

Note that the processes for each step of the flowchart in FIG. 8 are performed by the CPU 21 that serves as the computer inside of the information processing apparatus 120 executing a computer program that has been stored on a memory.

In step S801, the initialization processing of the movable apparatus system for the automatic creation of the second SLAM map is performed. Specifically, the movement control unit 133 movement controls the movable apparatus system 100 until the point on the map where the creation of the second SLAM map in the second region will begin. In addition, in step S802, the map creation control unit 114 creates the second SLAM map by duplicating the first SLAM map that has been recorded on the map recording unit and records the second SLAM map.

In step S803, the position and orientation measuring unit 112 startts the position and orientation measurements by reading the second SLAM map that has been recorded on the map recording unit 113. In addition, the movement control contents determining unit 125 sets the first movement information in the movement control unit 133 and starts the automatic travel of the movable apparatus system 100.

In addition, in step S804, the movement control unit 133 determines the next waypoint by reading the first movement information, and determines the movement contents for the movable apparatus system 100 (movement direction, movement distance, and movement velocity) in order to move to the next waypoint.

In step S805, the movement control unit 133 movement controls the movable apparatus system 100 based on the movement contents that were determined. Next, in step S806, the position and orientation control measuring unit 112 measures the position and orientation of the movable apparatus system 100 based on the first sensor data that was acquired from the first sensor data acquisition unit 111.

In step S807, the position and orientation measuring unit 112 determines whether or not the position and orientation measurements in step S806 have become unstable so that the current position and orientation of the movable apparatus system 100 is lost. In a case in which the current position and orientation is lost, the processing proceeds to step S712. If this is not the case, the processing proceeds to step S808.

In step S808, the position and orientation measuring unit 112 determines whether or not a change has occurred at the image feature point in the position and orientation coordinates in step S806 and if it is necessary to add a key frame. In a case in which it is necessary to add a key frame, the processing proceeds to step S809, and if this is not the case, it proceeds to step S810.

In step S809, the position and orientation measuring unit 112 updates the second SLAM map by adding a key frame. In step S810, the movement control unit 133 determines whether or not the movable apparatus system 100 has arrived at the next waypoint. In a case in which it has arrived at the goal waypoint, the processing proceeds to step S811, and if this is not the case, it returns to step S806.

In step S811, the movement control unit 133 judges whether or not the movable apparatus system 100 has arrived at the final destination. In a case in which it has arrived at the final destination, the processing proceeds to step 812, and if this is not the case, it returns to step S804.

Next, in step S812, the position and orientation measuring unit 112 completes the position and orientation measurements, and the movement control unit 133 completes the movement control of the movable apparatus system 100. The automatic travelling (autonomous travelling) is thereby completed.

Next, in step S813, the map recording unit 113 records the updated second SLAM map, and the processing is completed. Note that step S712 to step S717 in FIG. 8 are the same as step S712 to S717 in FIG. 7, and therefore an explanation thereof is omitted.

In a case in which it has been judged that the creation of the SLAM map will be completed in step S717, the processing proceeds to step S814, and the map control contents determining unit 123 completes the creation of the SLAM map, and the SLAM map is recorded by proceeding to step S813. In addition, in the case of No in step S713, the flow in FIG. 8 is completed.

According to the Sixth Embodiment, the accuracy of the position and orientation measurements is increased by updating the second SLAM map in the second region that has been created by duplicating the first SLAM map, and the safety of the movable apparatus system when automatically travelling is increased.

Note that in the Sixth Embodiment, the movement contents determining unit 125 controlled the movable apparatus system 100 such that it moves on travelling paths that are the same as those from a case in which it automatically travelled based on the first SLAM map in the first region. However, the present invention is not limited thereto.

For example, the movement control contents determining unit 125 may also change the path information that is set in the movable apparatus system 100 in the second region according to the degree of region similarity. Specifically, the first region and the second region are split into subareas, and a degree of region similarity is calculated for each subarea.

The path information may also be set in the movable apparatus system 100 such that it avoids subareas for which the degree of region similarity is low in the second region. It is thereby possible to decrease the risk of the movable apparatus system 100 colliding with a structure due to differences in the shapes of the layouts.

In this manner, according to the Sixth Embodiment, the accuracy of the position and orientation measurements is increased, and the safety for when the movable apparatus system is automatically travelling is increased by updating the second SLAM map that was created by duplicating the first SLAM map while moving in the second region

### Seventh Embodiment

In the Seventh Embodiment, determinations for the control contents of the SLAM map in a specific region, and determinations for the movement control contents for the movable apparatus system are continuously executed for a plurality of regions. Information including the position of the region is necessary for movement within a region during continuous execution in a plurality of regions, and this is acquired to serve as the region information. For example, in a case in which the plurality of regions is a plurality of floors in a building, the number of floors is acquired to serve as the region information.

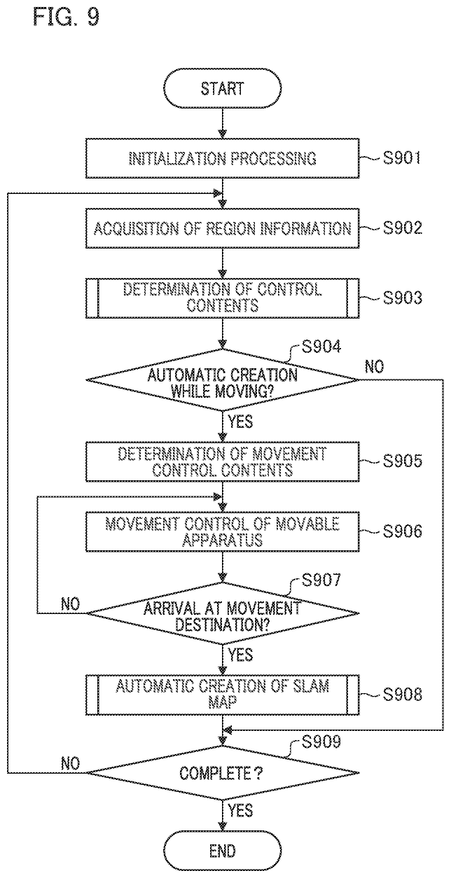

FIG. 9 is a flowchart showing the procedures of processing for the movable apparatus system according to the Seventh Embodiment. In FIG. 9, SLAM maps are continuously automatically created in a plurality of regions while movement controlling the movable apparatus system 100. Note that the processes for each step of the flowchart in FIG. 9 are performed by the CPU 21 that serves as the computer inside of the information processing apparatus 120 executing a computer program that has been stored on a memory.

In step S901, the initialization processing for the movable apparatus system for the automatic creation of the SLAM maps for the plurality of regions is performed. Specifically, the initial position of the movable apparatus system 100 in the current region is set.

In step S902, the region information acquisition unit 121 acquires information including a position in the target region from the input unit 131 to serve as the region information. In the present embodiment, the region information including the position in the target region is the number of floors for the building.

In step S903, the information processing apparatus 120 determines the control contents for the SLAM map in the target region, and determines the movement control contents for the movable apparatus system, both according to the processing procedures that were shown in FIG. 6.

In step S904, the movement control contents determining unit 125 judges whether or not it has been determined that movement control of the movable apparatus system 100 will be executed in order to automatically create a SLAM map in the target region. In a case in which the execution of movement control, that is the creation of the second SLAM map while moving, has been determined, the processing proceeds to step S905. In a case in which it has been determined that movement control will not be performed, the processing proceeds to step S909.

In step S905, the movement control content determining unit 125 determines the movement control contents relating to the movement to the target region from the current region based on the region information that was acquired in step S902. In addition, in step S906, the movement control unit 133 movement controls the movable apparatus system 100 according to the movement control contents that were determined in step S905.

In step S907, the movement control unit 133 judges whether or not the movable apparatus system 100 has arrived at the movement destination. In a case in which it has arrived at the movement destination, the processing proceeds to step S908. In a case in which it has not arrived at the movement destination, the processing returns to step S906, and the movement control continues.

In step S908, the movable apparatus system 100 executes the movement control for the movable apparatus system 100 according to the procedures of the processing shown in FIG. 7 in order to automatically create a SLAM map in the target region.

In step S909, the movement control contents determining unit 125 judges whether or not to execute automatic creation of the SLAM map for which the next region is the target. In a case in which a region for which the processing will be executed next exists, the process returns to step S902, and the processing continues. In contrast, in a case in which the processing for all of the regions has been completed, the processing is ended.

According to the Seventh Embodiment, it becomes possible to continuously execute the automatic creation of SLAM maps in a plurality of regions, and therefore, the operation procedures for the user can be reduced, and the usefulness is increased.

### Eighth Embodiment

In the Eighth Embodiment, an example will be explained in which the present invention has been applied to a movable apparatus system that automatically travels using visual SLAM. Note that in this context, visual SLAM refers to a technology for creating SLAM maps based on images from a camera. In the Eighth Embodiment, the SLAM map is created using visual SLAM.

In the Eighth Embodiment, a plurality of key frame information is included in the SLAM map. The key frames include captured images from a camera from when the map was created, and are associated with the position and posture of the camera. Furthermore, in addition to the key frames, the three-dimensional coordinate data for feature points that have been detected from the captured images is also included in the SLAM map.

In a case in which a SLAM map is created by visual SLAM, it is also necessary to make the movable apparatus travel on paths inside of a predetermined region in which the movable apparatus will automatically travel by the user pushing the movable apparatus by hand, or performing remote control operations, or the like, in the same manner as for LiDAR SLAM.

In cases in which visual SLAM is used, there are cases in which the image features in the regions are not similar even if the shapes of the layouts of the first region and the second region are similar. In such a case, if the first SLAM map that was created in the first region is reused and used to serve as the second SLAM map in the second region, the image features of the key frames in the position and orientation measurements by visual SLAM will not match, and the accuracy of the position and orientation measurements will be lowered. Therefore, the automatic travel of the movable apparatus system will become unstable.

In this context, in the Eighth Embodiment, in addition the degree of shape similarity relating to the shapes of the layouts, a degree of pattern similarity indicating the pattern (image) features from inside the region is further calculated to serve as the degree of region similarity. During the calculation of the degree of pattern similarity, the image data that was image captured using a camera within the region is compared.

In the Eighth Embodiment, the degree of region similarity is a value indicating to what extent the first region and the second region are similar with respect to the shapes of the layouts and the pattern features within the regions. The degree of similarity relating to the shapes of the layouts is made the degree of shape similarity, and the degree of similarity relating to the pattern features is made the degree of pattern similarity, and the degree of region similarity is expressed by the two parameters of the degree of shape similarity and the degree of pattern similarity.

In the present embodiment, the points of difference from FIG. 1, which shows a full configurational example of a movable apparatus system that is provided with the information processing apparatus that was explained in the First Embodiment, will be explained. Specifically, the lowest value for the degree of similarity is made 0.0, and the highest value for the degree of similarity is made 1.0.

The first sensor 101 generates first sensor data by performing sensing in a predetermined region in which the movable apparatus 100 travels. The first sensor 101 in the present embodiment uses a camera and generates image data in which a luminance value has been recorded in each pixel to serve as the first sensor data.

The eight embodiment uses the same configuration as the configuration in FIG. 3. The points of difference from FIG. 3 will be explained.

The region information acquisition unit 121 acquires first region information and second region information. In the present embodiment, the region information acquisition unit 121 acquires CAD data from the input unit 131 to serve as the region information that includes the shapes of the layouts relating to a region. In addition, it acquires image data that was image captured by the camera from the first sensor data recording unit 115 to serve as region information including the pattern (image) features within the region.

In the present embodiment, the points of difference with FIG. 4, which shows a flowchart showing the processing procedures for the image processing apparatus 120 that was explained in the First Embodiment, will be explained.

In step S402, the region information acquisition unit 121 acquires first CAD data to serve as the first region information, and second CAD data to serve as the second region information from the input unit 131. Furthermore, the region information acquisition unit 121 acquires first image data to serve as the first region information, and second image data to serve as the second region information from the first sensor data recording unit 115.

In step S403, the degree of region similarity calculating unit 122 calculates the degree of region similarity for the first region and the second region based on the first region information and the second region information. In the Eighth Embodiment, the degree of region similarity calculating unit 122 calculates the degree of shape similarity from the first CAD data and the second CAD data, and further calculates the degree of pattern similarity from the first image data and the second image data. The calculation method for the degree of pattern similarity will be described below.

In step S404, the map control contents determining unit 123 references the control contents table based on the calculated degree of region similarity, and determines the control contents for the second SLAM map in the second region. In the Eighth Embodiment, the map control contents generating unit 123 judges that the first SLAM map can be reused in cases in which the degree of shape similarity and the degree of pattern similarity in the calculated degree of region similarity are both at or above pre-determined thresholds that are set in advance.

In addition, it is determined that the first SLAM map that was created in the first region will be duplicated and created to serve as the second SLAM map in the second region. In contrast, in cases in which the degree of shape similarity and the degree of pattern similarity are both below the predetermined thresholds that have been set in advance, it is judged that the first SLAM map cannot be reused, and it is determined that the second SLAM map will be newly created.

As was described above, in the Eighth Embodiment, the degree of region similarity calculating unit 122 calculates the degree of pattern similarity from the first image data and the second image data. Specifically, the degree of region similarity calculating unit 122 detects objects that are included in the image data by image recognition.

The object detection is executed by template matching, deep learning, segmentation, or the like. In addition, the degree of pattern similarity is calculated from the matching rate for the feature amounts for the texture of each object in relation to the objects that have been detected. The texture of the objects shows the pattern features in the region such as the wallpaper, the interior, or the like. In a case in which the matching rate for the feature amounts for the textures is high, the degree of pattern similarity is calculated as being high.

According to the Eighth Embodiment, it is possible to create the second SLAM map by determining the similarity of not just the shapes of the layouts of the first region and the second region, but also of the pattern (image) features within the region. Therefore, the accuracy of the position and orientation measurements in the second region is improved, and the safety when the movable apparatus system is automatically travelling is increased.

Note that in the Eighth Embodiment, the region information acquisition unit 121 acquired image data that was image captured by a camera, which is the first sensor 101 that the movable apparatus system 100 is provided with, from the first sensor data recording unit 115. However, the present invention is not limited thereto. That is, it is sufficient if the image data has been captured from relatively the same position and orientation in the first region and the second region.

For example, monitoring cameras that have been disposed in relatively the same positions in the first region and the second region may also be used. In this case, it is sufficient if the image data has been captured by aligning the cameras in relatively the same direction. It is thereby possible to use image data that has been captured within the region at a wider angle of view than in a case in which image capturing is performed by the movable apparatus system 100, and the accuracy of the calculated degree of region similarity is increased, and the determination accuracy for the map control contents is also increased.

In addition, in the present embodiment, the region information acquisition unit 121 acquired one first image data that was captured within the first region, and one second image data that was captured in the second region. However, the present invention is not limited thereto, and a plurality of image data that was image captured at relatively the same position and orientation at a plurality of points on the map in the first region and in the second region may also be acquired.

In this case, the degree of region similarity calculating unit 122 will calculate the degree of pattern similarity for each image data that was captured at relatively the same position and orientation, and calculate the sum total thereof to serve as a final degree of pattern similarity. Thereby, the accuracy of the calculated degree of pattern similarity is raised and the determination accuracy for the map control contents is increased by also comparing pattern features for regions that are of a range that cannot be covered by one image data alone.

Note that in the Eighth Embodiment, the degree of region similarity calculating unit 122 detected objects that are included in the image data by image recognition and calculated the degree of pattern similarity from the matching rate for the feature amounts for the textures of each object. However, the present invention is not limited thereto, and this may also be calculated from the matching rate for the luminance of the image, or the matching rate of the colors of the objects that were detected.

In addition, in the Eighth Embodiment, the degree of region similarity calculating unit 122 calculated both the degree of shape similarity and the degree of region similarity. However, the present invention is not limited thereto, and one degree of region similarity may also be calculated from a weighted average of the degree of shape similarity and the degree of region similarity.

In this manner, according to the Eighth Embodiment, it is possible to create the second SLAM map by judging the similarity of not just the shapes of the layouts for the first region and the second region, but also of the pattern features within the regions. Therefore, the accuracy of the position and orientation measurements in the second region are increased, and the stability when the movable apparatus system is automatically travelling is increased.

### Ninth Embodiment

In the Ninth Embodiment, the movement control of the movable apparatus system in the second region has been applied to a movable apparatus system that automatically travels using visual SLAM. In particular, the Ninth Embodiment is effective in cases in which a portion of the shape and pattern features in the first region and the second region are different.

In the Ninth Embodiment, a configuration that is the same as that in FIG. 5 is used. The points of difference with FIG. 5 will be explained. The region information acquisition unit 121 acquires first region information and second region information. In the Ninth Embodiment, the region information acquisition unit 121 acquires CAD data to serve as the region information including the shapes of the layouts relating to the regions from the input unit 131. In addition, it acquires image data that was image captured by a camera to serve as the region information including the pattern (image) features inside the regions from the first sensor data recording unit 115.

In the Ninth Embodiment, a flow that is the same as that in FIG. 6 is used. The points of difference with FIG. 6 will be explained. Step S601, and step S602 are both the same as step S402, and step S403 of FIG. 4 that were explained in the Eighth Embodiment. In step S603, the map control contents determining unit 123 references the control contents table based on the calculated degree of region similarity, and determines the control contents for the second SLAM map in the second region. The determination method for the map control contents in the Ninth Embodiment will be explained below.

In step S605, the movement control contents determining unit 125 references the control contents table based on the degree of region similarity and the first movement information, and determines the movement control contents for the movable apparatus system 100 in the second region. The determination method for the movement control contents in the present embodiment will be explained below.

In the Ninth Embodiment, thresholds are set in the control contents table in relation to both the degree of shape similarity and the degree of pattern similarity, and these are both made the shape threshold and the pattern threshold. Further additionally, the shape threshold has a first shape threshold and a second shape threshold, and the first shape threshold is larger than the second shape threshold. In addition, the pattern threshold has a first pattern threshold and a second pattern threshold, and the first pattern threshold is larger than the second pattern threshold.

In the Ninth Embodiment, the map control contents determining unit 123 judges that the first SLAM map can be reused in a case in which the degree of shape similarity is at or above the first shape threshold, and the degree of pattern similarity is at or above the second shape threshold. In addition, it is determined that the first SLAM map will be duplicated and created to serve as the second SLAM map. In contrast, in all other cases, the map control contents determining unit 123 judges that the first SLAM map cannot be reused, and it is determined that the second SLAM map will be newly created.

In addition, if there is a case in which the degree of shape similarity is at or above the first shape threshold, and the degree of pattern similarity is at or above the first pattern threshold, the movement control contents determining unit 125 determines that movement control will not be performed in the second region.

In addition, if there is a case in which the degree of shape similarity is at or above the first shape threshold, and the degree of pattern similarity is less than the second pattern threshold, the movement control determining unit 125 determines that the movable apparatus system will be movement controlled in the second region, and the second SLAM map will be updated. This is the same as the method that was explained in the Sixth Embodiment.

Next, cases are assumed in which the degree of shape similarity is at or above the first threshold, and the degree of pattern similarity is less than the second pattern threshold, or in which the degree of shape similarity is less than the first threshold, and at or above the second shape threshold. In such cases, it is determined that the movable apparatus system 100 will be controlled so as to automatically move on paths that are the same as paths in which the movable apparatus system 100 moved when the first SLAM map was created in the first region based on the first movement information.

If there is a case in which the degree of shape similarity is less than the second shape threshold, the movement control contents determining unit 125 will determine that movement control will not be performed in the second region regardless of the degree of pattern similarity.

According to the Ninth Embodiment, even in a case in which a portion of the shapes of the layouts in the first region and the second region are different, or in a case in which a portion of the pattern features is different, it becomes possible to apply the present invention, and it is possible to reduce the workload for the creation of the second SLAM map.

Note that in the Ninth Embodiment, in a case in which the degree of shape similarity is at or above the first shape threshold, and the degree of pattern similarity is less than the first pattern threshold but at or above the second pattern threshold, the map control contents determining unit 123 duplicated the first SLAM map and created this to serve as the second SLAM map. In addition, the movement control contents determining unit 125 determined that the movable apparatus system would be movement controlled in the second region, and that the second SLAM map would be updated. However, the present invention is not limited thereto.

For example, the map control contents determining unit 123 may also change the extent to which the key frames of the second SLAM map are updated according to the degree of region similarity when updating the second SLAM map by movement controlling the movable apparatus system in the second region.

Specifically, in the subareas with a high degree of pattern similarity, the extent to which the key frames are updated is made low, and they are rarely updated, and the extent at which the key frames are updated is made high and they are frequently updated for the subareas in which the degree of pattern similarity is low. It is thereby possible to effectively update the second SLAM map, and it is possible to increase the processing effectiveness for the movable apparatus system.

In this manner, according to the Ninth Embodiment, it is possible to reduce the workload for creating the second SLAM map even in a case in which a portion of the shapes of the layouts for the first region and the second region differ, or a case in which a portion of the pattern features differ.

### Tenth Embodiment

In the eighth embodiment, a method was shown in which CAD data was used to serve as region information including the shapes of the layouts, and image data that was image captured by a camera was used to serve as the region information including the pattern features. In relation to this, in the Tenth Embodiment, the region information including the shapes of the layouts also uses image data that was image captured by a camera, and the degree of shape similarity is calculated from the matching rate for objects relating to the layout such as the walls, doors, or the like in relation to the objects that have been detected by image recognition.

In the Tenth Embodiment, the differences from FIG. 4, which is a flowchart showing the processing procedures for the information processing apparatus that was explained in the Eighth Embodiment, will be explained.

In step S402, the region information acquisition unit 121 acquires first image data to serve as the first region information, and second image data to serve as the second region information from the first sensor data recording unit 115.

In step S403, the degree of region similarity calculating unit 122 calculates the degree of region similarity for the first region and the second region based on the first region information and the second region information. In the Tenth Embodiment, the degree of region similarity calculating unit 122 calculates the degree of shape similarity and the degree of pattern similarity from the first image data and the second image data. In the Tenth Embodiment, the degree of region similarity calculating unit 122 detects objects that are included in the image data using image recognition.

In addition, from among the detected objects, object groups relating to the shapes of the layouts are extracted, and the degree of shape similarity is calculated from the matching rate for the image features for these extracted objects. The objects relating to the shapes of the layouts are, for example walls and paths, ceilings, doors, elevators, and the like, and are set in advance in the image recognition processing. In a case in which the matching rate for the image features is high, the degree of shape similarity is calculated as being high.

### Eleventh Embodiment

In the Eleventh Embodiment, both LiDAR SLAM and Visual SLAM are used together and applied to a movable apparatus system that travels automatically. In the Eleventh Embodiment, in a functional configurational example of a movable apparatus system that is provided with an information processing apparatus, the first sensor 101 has LiDAR and a camera, and the position and orientation measuring apparatus 110 performs LiDAR SLAM processing along with visual SLAM processing.

The region information acquisition unit 121 acquires group data using LiDAR and image data using a camara from both of the two types of position and orientation measurement apparatuses 110 that were explained above, in addition to CAD data. The region degree of similarity calculating unit 122 calculates a degree of shape similarity in which the point group data has been compared with, for example, the CAD data. Furthermore, the degree of region similarity calculating unit 122 calculates the degree of pattern similarity based on the image data.

According to the Eleventh Embodiment, it becomes possible to also apply the present invention to a movable apparatus system in which LiDAR SLAM and Visual SLAM are used together, and the flexibility of the system is increased.

In the above examples, it has been assumed that the movable apparatus moves on a two-dimensional plane. However, the present invention is not limited thereto, and for example, the movable apparatus may also be made to move on a three-dimensional plane, such as for a drone. In this case, it is sufficient if the position and orientation uses six parameters that combine the three parameters (X, Y, and Z) indicating the position in the three-dimensional space, and the three parameters (roll, pitch, and yaw) that indicates the posture in the three-dimensional space.

As has been explained in the above-described First to Eleventh Embodiments, the first region information includes feature point group data that has been acquired using CAD data or LiDAR, or image data that has been acquired using a camera, In addition, in the same manner, the second region information includes feature point group data that has been acquired using CAD data or LiDAR, or image data that has been acquired using a camera.

Note that in the above-described examples, examples have been explained in which the present invention has been applied to an autonomous movable apparatus. However, the movable apparatus of the present embodiment is not limited to an autonomous movable apparatus such as an AGV (Automated Guided Vehicle), an AMR (Autonomous Mobile Robot), or the like. In addition, the movable apparatus may also be an article that has a driving assistance use, and does not move completely autonomously.

In addition, the movable apparatus may also be any kind of moving apparatus that moves such an automobile, a train, a boat, an airplane, a robot, a drone, or the like. In addition, a portion of the information processing apparatus from the examples may also be built into the movable apparatus, but it does not necessarily need to be built into the movable apparatus. In addition, the present invention may also be applied in cases in which the movable apparatus is controlled using a remote. In addition, the above-described First Embodiment to the Eleventh Embodiment may also be suitably combined.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus through a network or various storage media. Then, a computer (or a CPU, an MPU, or the like) of the information processing apparatus may be configured to read and execute the program. In such a case, the program and the storage medium storing the program configure the present invention.

This application claims the benefit of Japanese Patent Application No. 2022-109743, filed on Jul. 7, 2022, which is hereby incorporated by reference herein in its entirety.

What is claimed is:

1. An information processing apparatus comprising at least one processor or circuit configured to function as:
a region information acquisition unit configured to acquire region information including at least one of a shape feature or a pattern feature relating to a predetermined region;
a degree of region similarity calculating unit configured to calculate a degree of similarity between a first region and a second region based on first region information relating to the first region and second region information relating to the second region that have been acquired by the region information acquisition unit; and
a map information determining unit configured to acquire second map information relating to the second region based on first map information relating to the first region in a case in which the degree of similarity that has been calculated by the degree of region similarity calculation unit is at or above a predetermined threshold.

2. The information processing apparatus according to claim 1, wherein in a case in which the degree of similarity is at or above the predetermined threshold, the map information determining unit uses the first map information to serve as the second map information.

3. The information processing apparatus according to claim 1, wherein the region information acquisition unit acquires movement history information for a movable apparatus in the first region, and the information processing apparatus has a movement control contents determining unit configured to control the movement of a movable apparatus in the second region based on the degree of similarity that was calculated by the degree of region similarity calculating unit, and the movement history information.

4. The information processing apparatus according to claim 3, wherein the movement history information includes information relating to the movement history for the movable apparatus from when the first map information was created in the first region.

5. The information processing apparatus according to claim 3, wherein, in a case in which the degree of similarity is lower than the predetermined threshold, the movement control contents determining unit controls the movement of the movable apparatus, the second map information is created based on an output from a sensor that has been provided on the movable apparatus.

6. The information processing apparatus according to claim 3, wherein the movement control contents determining unit has a manual mode in which the movement of the movable apparatus is controlled in the second region based on commands from a user.

7. The information processing apparatus according to claim 1, wherein the first region information includes feature point group data that was acquired using CAD data or LiDAR, or includes image data that was acquired using a camera.

8. The information processing apparatus according to claim 1, wherein the second region information includes feature point group data that was acquired using CAD data or LiDAR, or includes image data that was acquired using a camera.

9. An information processing method comprising:
region information acquiring in which region information including at least one of a shape feature or a pattern feature relating to a predetermined region is acquired;
degree of region similarity calculating in which a degree of similarity between a first region and a second region is calculated based on first region information relating to the first region and second region information relating to the second region that have been acquired by the region information acquiring; and
map information determining in which, in a case in which the degree of similarity that has been calculated by the degree of region similarity calculating is at or above a predetermined threshold, second map information relating to the second region is acquired based on first map information relating to the first region.

10. A non-transitory computer-readable storage medium storing a computer program including instructions for executing the following processes:
region information acquiring in which region information including at least one of a shape feature or a pattern feature relating to a predetermined region is acquired;
degree of region similarity calculating in which a degree of similarity between a first region and a second region is calculated based on first region information relating to the first region and second region information relating to the second region that have been acquired by the region information acquiring; and
map information determining in which, in a case in which the degree of similarity that has been calculated by the degree of region similarity calculating is at or above a predetermined threshold, second map information relating to the second region is acquired based on first map information relating to the first region.
